(19) United States
(12) Patent Application Publication
(10) Pub. No.: US 2026/0308019 A1
(43) Pub. Date: Oct. 8, 2026

(54) REMOVAL OF PER- AND POLYFLUOROALKYL SUBSTANCES (PFAS) FROM WATER WITH MESO- AND MACRO-POROUS GELS

(71) Applicant: THE UNIVERSITY OF AKRON, Akron, OH (US)

(72) Inventors: Sadhan Jana, Fairlawn, OH (US); Pratik Gotad, Akron, OH (US)

(21) Appl. No.: 19/482,644

(22) PCT Filed: Mar. 11, 2024
(86) PCT No.: PCT/US2024/019415

§ 371 Date: Nov. 7, 2025

Related U.S. Application Data
(60) Provisional application No. 63/465,108, filed on May 9, 2023.

(51) Int. Cl. C02F 1/28; B01J 20/26; B01J 20/28; B01J 20/30; C02F 101/36

(52) U.S. Cl. CPC C02F 1/285; B01J 20/267; B01J 20/28047; B01J 20/28061; B01J 20/28064; B01J 20/28083; B01J 20/28085; B01J 20/3085; C02F 2101/36; C02F 2307/10

(57) ABSTRACT

A polymer gel for removing undesired compounds from water includes polymer chains having an interconnected network of mesopores and macropores. The polymer gel has a relatively high surface and total porosity. The polymer gel is capable of producing a water product having less than 10 ng/L of per- and polyfluoroalkyl substances (PFAS). Corresponding methods and systems are also disclosed.

### CROSS REFERENCE TO RELATED APPLICATIONS

This application claims the benefit of U.S. provisional patent application Ser. No. 63/465,108, filed May 9, 2023, which is incorporated by reference herein.

### STATEMENT REGARDING FEDERALLY SPONSORED RESEARCH

This invention was made with government support under grant CMMI 1826030 awarded by the National Science Foundation. The government has certain rights in the invention.

### FIELD OF THE INVENTION

One or more embodiments of the invention are directed toward polymer gels which include an interconnected network of mesopores and macropores for removal of undesired compounds, such as per- and polyfluoroalkyl substances (PFAS), from water. One or more embodiments of the invention are directed toward corresponding systems and methods for removing PFAS from water.

### BACKGROUND

Per- and polyfluoroalkyl substances (PFAS) are a group of manufactured chemicals which are used in manufacturing poly(tetrafluoroethylene) and in certain consumer products such as food packaging, clothing, coatings, and menstrual products. PFAS are recognized as contaminants of emerging concern due to their toxicity, bioaccumulation, and stability. PFAS include extremely stable carbon-fluorine bonds and have therefore been deemed as ‘forever chemicals.’ The United States Environmental Protection Agency (EPA) has listed them among the top priority contaminants. The US EPA has identified around 430 PFAS molecules obtained from various water sources and has included 74 chemicals in the top priority list targeted for obtaining additional toxicity data.

An exemplary PFAS compound is perfluorooctanoic acid (PFOA), which may be considered the most widespread PFAS contaminant present in the environment, though PFOA has been generally phased out. Several techniques, such as chemical oxidation, foam fractionation, coagulation, ion-exchange, and filtration, have been studied for PFOA removal or degradation. Certain natural and synthetic adsorbent media have also been utilized based on their effectiveness for separation of PFOA molecules compared to other conventional technologies. Some conventional adsorbents include granular/powdered activated carbon, amine containing compounds, biochar, and ion exchange resins.

However, a few known drawbacks limit the performance of these adsorbents relative to PFOA separation. For example, activated carbon suffers from low affinity for PFOA at environmentally relevant concentrations (e.g., less than about 1 μg/L), long adsorption times, low effectiveness for short-chain PFAS molecule separation, poor performance in the presence of other organic contaminants, and difficulty in regeneration of the adsorbent bed. Other adsorption media, such as β-cyclodextrin (β-CD) and ion-exchange resins, offer extremely low specific surface area and hence, low adsorption capacities, thus requiring frequent regeneration of the adsorbent bed. Ion exchange resins are also highly selective towards either anionic or cationic PFAS, such that their performance for separation of non-ionic molecules is poor and their effectiveness for PFAS separation in the presence of other salts in water is low. Most importantly, the conventional adsorbent materials have generally not been associated with separation of PFOA at the desired low concentrations (e.g., less than about 1 μg/L), thus limiting their effectiveness for the separation.

There remains a need in the art for improvements for removing undesired compounds, such as PFAS, from water.

### SUMMARY

In a first embodiment, the present invention provides a polymer gel for removing undesired compounds from water, the polymer gel comprising polymer chains having an interconnected network of mesopores and macropores therebetween, the mesopores having pore sizes between about 2 nm and 50 nm and the macropores having pore sizes greater than about 50 nm, wherein the polymer gel has a surface area of from about 200 m²/g to about 1,000 m²/g, and wherein the polymer gel has a total porosity of from about 90% to about 97%.

In a second embodiment, the present invention provides a polymer gel as in any of the above embodiments, wherein the polymer gel is capable of producing a water product having less than 10 ng/L, or less than 1 ng/L, of per- and polyfluoroalkyl substances (PFAS).

In a third embodiment, the present invention provides a polymer gel as in any of the above embodiments, wherein the polymer chains include polystyrene, polyimide, polyurea, polyurethane, chitosan, silica, polybenzoxazine, or cellulose.

In a fourth embodiment, the present invention provides a polymer gel as in any of the above embodiments, wherein the polymer chains include syndiotactic polystyrene.

In a fifth embodiment, the present invention provides a polymer gel as in any of the above embodiments, wherein the mesopores and macropores are filled with water, such that the polymer gel is a hydrogel.

In a sixth embodiment, the present invention provides a polymer gel as in any of the first through fourth embodiments, wherein the mesopores and macropores are filled with air, such that the polymer gel is an aerogel.

In a seventh embodiment, the present invention provides a polymer gel as in any of the above embodiments, wherein the polymer gel includes from about 1% to about 15% of the mesopores and from about 85% to about 99% of the macropores relative to a total number of pores.

In an eighth embodiment, the present invention provides a polymer gel as in any of the above embodiments, wherein the polymer gel is shaped as a monolith, a sheet, a film, spherical microparticles, or pill-shaped microparticles.

In a ninth embodiment, the present invention provides a polymer gel as in any of the above embodiments, wherein the polymer gel has a water contact angle of greater than 60°.

In a tenth embodiment, the present invention provides a polymer gel as in any of the above embodiments, wherein the polymer gel includes generally constant bulk properties across an entirety of the polymer gel.

In an eleventh embodiment, the present invention provides a polymer gel as in any of the first through tenth embodiments, wherein the polymer gel includes a first section having a first set of generally constant bulk properties and a second section having a second set of generally constant bulk properties different from the first set of generally constant bulk properties.

In a twelfth embodiment, the present invention provides a polymer gel as in any of the above embodiments, wherein the polymer gel is within a personal water dispenser or a city water treatment system.

In a thirteenth embodiment, the present invention provides a polymer gel as in any of the above embodiments, wherein the polymer chains include a functionalized polymer having a functionalizing agent selected from sulfonic acid, amine, carboxylic acid, and benzene.

In a fourteenth embodiment, the present invention provides a polymer gel as in any of the above embodiments, wherein the polymer gel comprises a sequestering additive, where the sequestering additive includes a cyclodextrin.

In a fifteenth embodiment, the present invention provides a system or method including the polymer gel as in any of the above embodiments.

In a sixteenth embodiment, the present invention provides a system for removal of per- and polyfluoroalkyl substances (PFAS) from water, the system including an inlet providing a PFAS-containing water stream; a polymer gel adapted to receive the PFAS-containing water stream via the inlet; an outlet adapted to output a product water stream having a lower concentration of PFAS than the PFAS-containing water stream; wherein the product water stream having the lower concentration of PFAS includes less than 10 ng/L, or less than 1 ng/L, of the PFAS.

In a seventeenth embodiment, the present invention provides a system as in any of the above embodiments, further comprising a housing which carries the polymer gel.

In an eighteenth embodiment, the present invention provides a system as in any of the above embodiments, wherein the housing is part of a personal water dispenser or a city water treatment system.

In a nineteenth embodiment, the present invention provides a system as in any of the above embodiments, wherein the housing is the part of the personal water dispenser and wherein the system is adapted for batch operation.

In a twentieth embodiment, the present invention provides a system as in any of the above embodiments, wherein the housing is the part of the city water treatment system and wherein the system is adapted for continuous operation.

In a twenty-first embodiment, the present invention provides a system as in any of the above embodiments, wherein the product water stream having the lower concentration of PFAS includes perfluorooctanoic acid (PFOA) at a concentration of less than 0.004 ng/L and perfluorooctane sulfonate (PFOS) at a concentration of less than 0.02 ng/L.

In a twenty-second embodiment, the present invention provides a method for removing per- and polyfluoroalkyl substances (PFAS) from water, the method including providing a PFAS-containing water stream to a polymer gel, the PFAS-containing water stream including PFAS at a concentration of from about 0.001 μg/L to about 1 μg/L; allowing the polymer gel to adsorb the PFAS within the PFAS-containing water stream; and collecting a product having a PFAS concentration of less than 1 ng/L.

In a twenty-third embodiment, the present invention provides a method as in any of the above embodiments, wherein the product having the PFAS concentration of less than 1 ng/L includes perfluorooctanoic acid (PFOA) at a concentration of less than 0.004 ng/L and perfluorooctane sulfonate (PFOS) at a concentration of less than 0.02 ng/L.

In a twenty-fourth embodiment, the present invention provides a method as in any of the above embodiments, further including preparing the polymer gel by preparing a solution of polymer in a first solvent; physically crosslinking or chemically crosslinking the polymer to produce an intermediate polymer gel; and solvent exchanging the first solvent with water to thereby form the polymer gel as a water-filled gel.

In a twenty-fifth embodiment, the present invention provides a method as in any of the above embodiments, further including preparing the polymer gel by preparing a solution of polymer in a first solvent; physically crosslinking or chemically crosslinking the polymer to produce an intermediate polymer gel; supercritically drying the intermediate polymer gel to form an aerogel; and adding water to the aerogel to thereby form the polymer gel as a water-filled gel.

### BRIEF DESCRIPTION OF THE DRAWINGS

Advantages of the present invention will become better understood with regard to the following description, appended claims, and accompanying drawings wherein:

FIG. 1 is a schematic of a gel containing mesopores and macropores according to one or more embodiments of the present invention;

FIG. 2 is a schematic of the gel containing mesopores and macropores, along with positive ions and sequestering molecules, according to one or more embodiments of the present invention;

FIG. 3 is a schematic of the gel containing mesopores and macropores, shown with two distinct layers, according to one or more embodiments of the present invention;

FIG. 4 is a schematic of the gel containing mesopores and macropores, shown within water which contains per- and polyfluoroalkyl substances (PFAS), according to one or more embodiments of the present invention;

FIG. 5 is a schematic of a system for filtering undesired compounds, according to one or more embodiments of the present invention; and

FIG. 6 is scanning electron microscope (SEM) images of the gel containing mesopores and macropores, with different pore properties, according to one or more embodiments of the present invention.

### DETAILED DESCRIPTION

Embodiments of the invention are based, at least in part, on polymer gels which are suitable for removal of undesired compounds from water. Exemplary undesired compounds for removal from water include per- and polyfluoroalkyl substances (PFAS)). The polymer gels include an interconnected network of mesopores and macropores for the removal of the PFAS from water. One or more embodiments of the invention are directed toward corresponding methods for removing PFAS from water. That is, the polymer gels can be used to filter out PFAS from a water stream or a water volume which contains PFAS. Advantageously, embodiments of the present invention are able to sufficiently remove a variety of PFAS compounds, with two examples being perfluorooctanoic acid (PFOA) and perfluorooctane sulfonate (PFOS). Embodiments of the present invention are able to sufficiently remove the PFOA and PFOS in order to meet the June 2022 Environmental Protection Agency (EPA) guidelines for admissible levels of PFOA concentration (0.004 parts per trillion (ppt); 0.004 ng/L) and PFOS concentration (0.02 ppt; 0.02 ng/L). That is, the polymer gels disclosed herein offer high affinity for PFAS (e.g., PFOA and PFOS) at environmentally relevant concentrations. The polymer gels disclosed herein also offer high adsorption capacity, rapid adsorption kinetics, and inexpensive regeneration to address the emerging environmental limits and ensuing health hazards presented by PFAS.

The properties and composition of the polymer gels can be tuned for a desired separation performance for removal of the undesired compounds (e.g., PFAS). The properties and composition, and the separation performance, can be adapted for any given water stream and for particular PFAS compounds within a given water stream. As discussed further herein, exemplary aspects which can be tuned for the polymer gels include surface area, surface energy, porosity, mesopore volume fraction, macropore volume fraction, pore architecture, polymer concentration in solvent, polymer composition, and compositional additives.

The tuning of these aspects can be based on one or more certain mechanisms for removal of PFAS.

A first mechanism which can be considered is the surface properties of the polymer gel. That is, providing the polymer gel with a relatively high surface area and a relatively high surface energy can provide a large number of sites and a large driving force, respectively, for PFAS adsorption. In conjunction, the polymer gel should include a sufficient amount of mesopores to enable confinement of the adsorbed PFAS.

A second mechanism which can be considered is the use of certain compositional materials relative to ionic charge. That is, certain compositional materials may be utilized based on their ability to adsorb the negatively charged PFAS (e.g., PFOA and PFOS) by electrostatic attraction forces. Exemplary compositional materials which may be utilized for adsorbing negatively charged PFAS include polyureas, polyurethanes, and chitosan.

A third mechanism which can be considered is the incorporation of a sequestering additive with the polymer gel. Sequestering additives can be materials which include molecular cavities with sizes similar to PFAS molecules. The sequestering additives can be incorporated either by physical binding or chemical binding. Having molecular cavities with sizes similar to PFAS molecules allows the sequestering additives to capture the PFAS molecules effectively. Cyclodextrins are an exemplary sequestering additive.

As mentioned above, the polymer gel should have a relatively high surface area. In one or more embodiments, the surface area of the polymer gel ranges from about 200 m²/g to about 1,000 m²/g, in other embodiments, from about 300 m²/g to about 900 m²/g, in other embodiments, from about 300 m²/g to about 700 m²/g, and in other embodiments, from about 200 m²/g to about 500 m²/g. In these or other embodiments, the surface area of the polymer gel may be up to about 1,100 m²/g, or up to about 1,200 m²/g, or up to about 1,300 m²/g. In these or other embodiments, the surface area of the polymer gel is greater than 200 m²/g, or greater than 300 m²/g, or greater than 400 m²/g, or greater than 500 m²/g. Surface area of the polymer gel can be measured by Brunauer-Emmett-Teller (BET) adsorption-desorption analysis.

In one or more embodiments, the surface area of the polymer gel can be closely matched to the surface area of certain PFAS (e.g., for a given water stream) in order to provide selectivity for particular PFAS. This can include testing a water stream to learn the surface energy of the PFAS in the water stream. In one or more embodiments, the surface area of the polymer gel can be matched to about 10%, in other embodiments, about 20%, in other embodiments, about 30%, and in other embodiments, about 40%, of the surface area of the PFAS.

As mentioned above, the polymer gel should have a relatively high surface energy. Surface energy can be defined based on water contact angle. In one or more embodiments, the polymer gel has a water contact angle of about 60°, in other embodiments, about 70°, and in other embodiments, about 80°. In one or more embodiments, the polymer gel has a water contact angle of greater than 60°, in other embodiments, greater than 70°, and in other embodiments, greater than 80°. Water contact angle can be measured using either an optical tensiometer or a force tensiometer.

The polymer gel should have a relatively high total porosity. In one or more embodiments, the porosity of the polymer gel ranges from about 90% to about 99%, in other embodiments, from about 90% to about 97%, in other embodiments, from about 93% to about 97%, and in other embodiments, from about 95% to about 97%. In one or more embodiments, the porosity of the polymer gel is greater than 90%, in other embodiments, greater than 93%, in other embodiments, greater than 95%, and in other embodiments, greater than 97%. Porosity (Π_{T}) of the polymer gel can be measured based on skeletal density (ρₛ) and bulk density (ρ_{b}) by Π_{T}=(1−ρ_{b}/ρₛ)×100. Skeletal density can be measured with a helium pycnometer and bulk density can be measured based on weight and volume of a specimen.

The polymer gel should have a relatively high total pore volume. In one or more embodiments, the total pore volume of the polymer gel ranges from about 10 cm³/g to about 40 cm³/g, in other embodiments, from about 15 cm³/g to about 35 cm³/g, in other embodiments, from about 10 cm³/g to about 30 cm³/g, and in other embodiments, from about 20 cm³/g to about 30 cm³/g. In one or more embodiments, the total pore volume of the polymer gel is greater than 10 cm³/g, in other embodiments, greater than 20 cm³/g, in other embodiments, greater than 25 cm³/g, and in other embodiments, greater than 30 cm³/g. Total pore volume (V_{Total}) of the polymer gel can be measured based on skeletal density (ρₛ) and bulk density (ρ_{b}) by V_{Total}=(1/ρ_{b})−(1/ρₛ).

As mentioned above, the polymer gels include an interconnected network of mesopores and macropores. Mesopores have pore sizes between about 2 nm and 50 nm and macropores have pore sizes greater than about 50 nm. The polymer gels may include a small amount of micropores having pore sizes less than 2 nm. Though many PFAS have sizes of about 2 nm so micropores will generally be undesirable. In one or more embodiments, the polymer gel can be substantially devoid of, or devoid of, micropores having pore sizes less than 2 nm.

In one or more embodiments, the macropores have pore sizes of from about 50 nm to about 500 nm, in other embodiments, from about 50 nm to about 400 nm, in other embodiments, from about 50 nm to about 300 nm, and in other embodiments, from about 50 nm to about 200 nm.

The interconnected network of mesopores and macropores of the polymer gel can be characterized relative to the amounts of mesopores and macropores relative to the total amount of pores. In one or more embodiments, the polymer gel includes from about 1% to about 15%, in other embodiments, from about 1% to about 10%, in other embodiments, from about 2% to about 8%, and in other embodiments, from about 2% to about 5%, of mesopores. In one or more embodiments, the polymer gel includes less than 10%, in other embodiments, less than 8%, in other embodiments, less than 5%, and in other embodiments, less than 3%, of mesopores. The amount of mesopores, which may be referred to as mesopore volume fraction, may be determined using a nonlocal density functional theory (NLDFT) model for N₂ isotherms at 77 K.

In one or more embodiments, the polymer gel includes from about 85% to about 99%, in other embodiments, from about 90% to about 99%, in other embodiments, from about 92% to about 98%, and in other embodiments, from about 95% to about 98%, of macropores. In one or more embodiments, the polymer gel includes greater than 90%, in other embodiments, greater than 92%, in other embodiments, greater than 95%, and in other embodiments, greater than 97%, of macropores. The amount of macropores, which may be referred to as macropore volume fraction, may be determined from the difference of total pore volume and the mesopore volume.

While the above properties can be varied for a particular polymer gel, the polymer gel can include generally constant bulk properties across the entirety of the polymer gel. In other embodiments, the polymer gel can include different layers or sections where the different layers or sections include different bulk properties. That is, a polymer gel can include a first section having a first set of generally constant bulk properties and a second section having a second set of generally constant bulk properties. The generally constant bulk properties can be defined as being within +/−2%, or within +/−5%, or within +/−10%, or within +/−15%, across the gel or across the section. Where different sections are utilized, the different sections can have differences in the bulk properties of at least 10%, or at least 15%, or at least 25%, or at least 30%, or at least 50%. Where different sections are utilized, the different sections can have differences in the bulk properties of about 10%, or about 15%, or about 25%, or about 30%, or about 50%. The sections having different bulk properties can be organized in the thickness direction, or in other embodiments, can be inner and outer sections (e.g., concentrical). The sections having different bulk properties can be adapted to adsorb different types of PFAS. That is, a first section having a first set of bulk properties can be adapted to adsorb a first PFAS compound or compounds and a second section having a second set of bulk properties can be adapted to adsorb a second PFAS compound or compounds.

The polymer gel can be formed by any suitable technique known to the person reasonably skilled in the art. The polymer gel can be formed by first preparing a polymer sol. That is, the polymer gel can be formed by thermo-reversible gelation of a solution of polymer in a solvent (e.g., toluene). This generally includes transforming the polymer solution to a gel state by elevating the temperature to a certain temperature. The polymer sol can be physically crosslinked or chemically crosslinked to form the polymer gel, which may be referred to as an intermediate polymer gel prior to a solvent exchange. The solvent (e.g., toluene) used to form the intermediate polymer gel can then be solvent exchanged with a subsequent desired solvent (i.e., water) to form a solvent-filled gel for separation of PFAS from water. The solvent-filled gel can be a water-filled gel, which can also be referred to as a hydrogel. The solvent exchanging may include solvent exchange with an intermediate solvent (e.g., ethanol) prior to the solvent exchange with water.

In one or more embodiments, a solvent-filled polymer gel can be supercritically dried to replace the liquid (i.e., solvent) in the polymer gel with gas (e.g., carbon dioxide or air) to obtain an aerogel. A supercritical drying step should occur at parameters such that the polymer gel does not experience surface tension force and capillary condensation in order to retain the pore structure of the aerogel. Obtaining an aerogel might be done in order to be able to ship the dry aerogel to an end use location. Water would then be added to the dry aerogel, which may be referred to pre-wetting or priming, by the end user prior to process operation. Pre-wetting may be referred to as causing the dry aerogel to reach sufficient saturation to thereby become the water-filled gel for separation of PFAS from water.

As mentioned above, the polymer material used to make the polymer gel can be tuned relative to a given PFAS removal. Exemplary polymers which can be used to make the polymer gel include polystyrene (e.g., syndiotactic polystyrene (sPS)), polyimide, polyurea, polyurethane, chitosan, silica, polybenzoxazine, and cellulose. The monomers used to make the polymer, and any catalysts and polymerization conditions will be generally known to the person reasonably skilled in the art. The polymers can be modified/functionalized, such as to adjust the surface energy. Exemplary functionalizing agents include sulfonic acid, amines, carboxylic acid, and benzene. As mentioned above, a sequestering additive can be incorporated with the polymer gel, which can be by spraying or soaking the polymer gel with the sequestering additive. Cyclodextrins are exemplary sequestering additives. Either by selection of a particular polymer material, functionalizing agent, or sequestering additive, or by a method to form a positive charge/positive ions, the polymer gel can also include a more positive ionic charge. This more positive ionic charge can serve to further attract negatively charged PFAS molecules for adsorption thereof.

The concentration of the polymer material within a solution of the polymer in a solvent (e.g., toluene) for the gelation process can be tuned according to the desired properties for the resulting polymer gel. Generally speaking, relatively higher solid polymer concentrations in the gel will result in an increase of polymer strand diameter, and therefore a relative reduction of the pore size and pore volume of the gel. That is, a relatively lower solid polymer concentration in the gel will generally result in a more open pore structure. The polymer concentration should be tuned to achieve desired pore properties for the polymer gel.

In one or more embodiments, the solid polymer concentration of a polymer and solvent solution is from about 0.01 g/mL to about 0.20 g/mL, in other embodiments, from about 0.02 g/mL to about 0.10 g/mL, in other embodiments, from about 0.05 g/mL to about 0.15 g/mL, and in other embodiments, from about 0.02 g/mL to about 0.05 g/mL. In one or more embodiments, the solid polymer concentration of a polymer and solvent solution is about 0.02 g/mL, in other embodiments, about 0.05 g/mL, in other embodiments, about 0.08 g/mL, and in other embodiments, about 0.1 g/mL.

The polymer gels are able to remove a wide variety of undesired compounds. Exemplary undesired compounds include fluorinated compounds, and PFAS compounds may be a targeted group of fluorinated compounds. While certain disclosure herein is therefore directed specifically to PFAS, it should be appreciated that this disclosure can also be extended to other undesired compounds, as appropriate.

Exemplary PFAS compounds which can be removed by the polymer gels include perfluorooctanoic acid (PFOA), perfluorooctanesulphonic acid (PFOS), perfluorobutanoic acid (PFBA), perfluorobutanesulphonic acid (PFBS), and those compounds under the tradename GenX. Other fluorinated compounds which may be targeted for removal include fluorinated byproducts. Exemplary fluorinated byproducts can include byproducts of the thermal decomposition of PFAS, as well as long-chain perfluoroalkyl carboxylates (LCPFAC), which may be produced during the manufacture of certain fluorinated polyolefins.

It has been found that the adsorption isotherm of at least certain PFAS (e.g., PFOA) is a sigmoidal shape. Without being bound by any theory, this indicates a two-step adsorption mechanism. A first mechanism can be attributed to strong affinity of PFAS molecules to the polymer surface. A second mechanism can be attributed to molecular aggregation at solid-liquid interfaces and/or within the pores of the polymer gel.

As suggested above, a fluid (e.g., water) having undesired compounds (e.g., PFAS) therein can be provided to the polymer gel for removal of the undesired compounds. The water for PFAS removal can be drinking water. Other applications of PFAS removal from water can include medical applications, such as intravenous fluids.

The initial water may be characterized relative to the amount of PFAS within the water. The amount of PFAS within the water may be at an environmentally relevant low concentration (e.g., less than about 1 μg/L), as the polymer gel disclosed herein is generally suitable for removal of PFAS at these low concentrations. In one or more embodiments, the amount of PFAS within the water provided to the polymer gel may be less than 1 μg/L, in other embodiments, less than 0.1 μg/L, in other embodiments, less than 0.01 μg/L, in other embodiments, less than 0.001 μg/L, and in other embodiments, less than 0.0001 μg/L. In one or more embodiments, the amount of PFAS within the water provided to the polymer gel may be from about 0.0001 μg/L to about 1 μg/L, in other embodiments, from about 0.001 μg/L to about 1 μg/L, in other embodiments, from about 0.1 μg/L to about 1 μg/L, in other embodiments, from about 0.01 μg/L to about 0.1 μg/L, and in other embodiments, from about 0.001 μg/L to about 0.01 μg/L.

The water product may be characterized relative to the amount of PFAS within the water. The amount of PFAS within the water product may be less than EPA assigned health advisory limits. In one or more embodiments, the amount of PFAS within the water product is less than 10 ng/L, in other embodiments, less than 5 ng/L, in other embodiments, less than 1 ng/L, in other embodiments, less than 0.5 ng/L, in other embodiments, less than 0.1 ng/L, and in other embodiments, less than 0.05 ng/L. In one or more embodiments, the amount of PFOA within the water product is less than 0.004 ng/L. In one or more embodiments, the amount of PFOS within the water product is less than 0.02 ng/L.

The polymer gel can be characterized by separation efficiency, which generally is a measure of the effectiveness of the polymer gel to remove PFAS from water. Separation efficiency can be calculated by

$$Efficiency = \frac{{C}_{inlet} - {C}_{outlet}}{{C}_{inlet}} \times 100 \%$$

where Cᵢₙₗₑₜ is the inlet concentration of the PFAS in water and Cₒᵤₜₗₑₜ is the concentration of the PFAS in the water product exiting the polymer gel.

The polymer gel can have any suitable separation efficiency. In one or more embodiments, the polymer gel has a separation efficiency of greater than 90%, in other embodiments, greater than 95%, in other embodiments, greater than 98%, in other embodiments, greater than 99%, in other embodiments, greater than 99.5%, in other embodiments, greater than 99.8%, in other embodiments, greater than 99.9%, and in other embodiments, greater than 99.95%. In one or more embodiments, the polymer gel has a separation efficiency of about 95%, in other embodiments, about 98%, in other embodiments, about 99%, in other embodiments, about 99.5%, and in other embodiments, about 99.9%.

The polymer gel can be exposed to the PFAS-containing water for any suitable amount of time. Longer times can generally lead to extra separation efficiency, though a lower separation efficiency at a lower time may be suitable. The separation efficiency can depend on a number of factors, including inlet concentration of PFAS, pore properties, amount of polymer gel utilized, and the shape of the polymer gel. With the tuning of the various properties, it is expected that suitable separation efficiencies at suitable times can be achieved relative to the targets (e.g., EPA targets) for PFAS removal.

In one or more embodiments, the polymer gel is exposed to the PFAS-containing water for from about 1 minute to 1 hour, in other embodiments, from about 1 hour to 5 hours, in other embodiments, from about 1 hour to 24 hours, in other embodiments, from about 5 minutes to 30 minutes, and in other embodiments, from about 5 minutes to 15 minutes.

With particular reference to FIGS. 1 to 5, one or more embodiments of the present invention provide a polymer gel 10, which may also be referred to as a gel 10 or a polymer structure 10. Polymer gel 10 includes a plurality of polymer chains 12 having pores 14 therebetween. Pores 14 include mesopores and macropores. As suggested above, pores 14 can be filled with a gas in a pre-use condition, or can be filled with a liquid (e.g., water) in a use condition.

Polymer gel 10 can be rendered into various shapes and sizes, with exemplary shapes including monoliths, sheets, films, and spherical or pill-shaped microparticles.

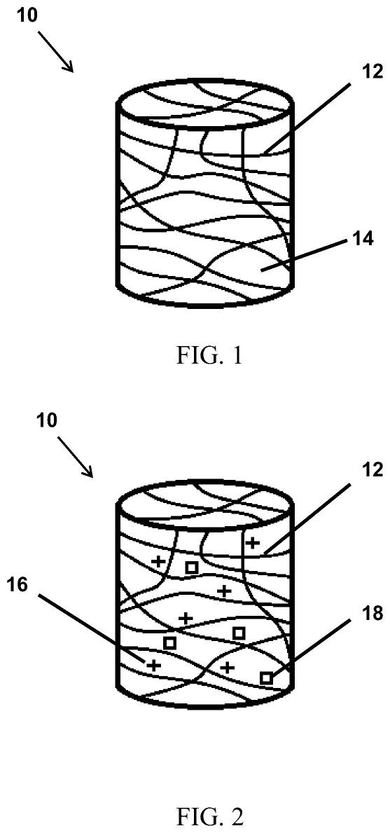

As shown in FIG. 1, in one or more embodiments, polymer gel 10 can be made of only the polymer chains 12. As shown in FIG. 2, in one or more embodiments, polymer gel 10 can further include positive ions 16 and/or sequestering additives 18.

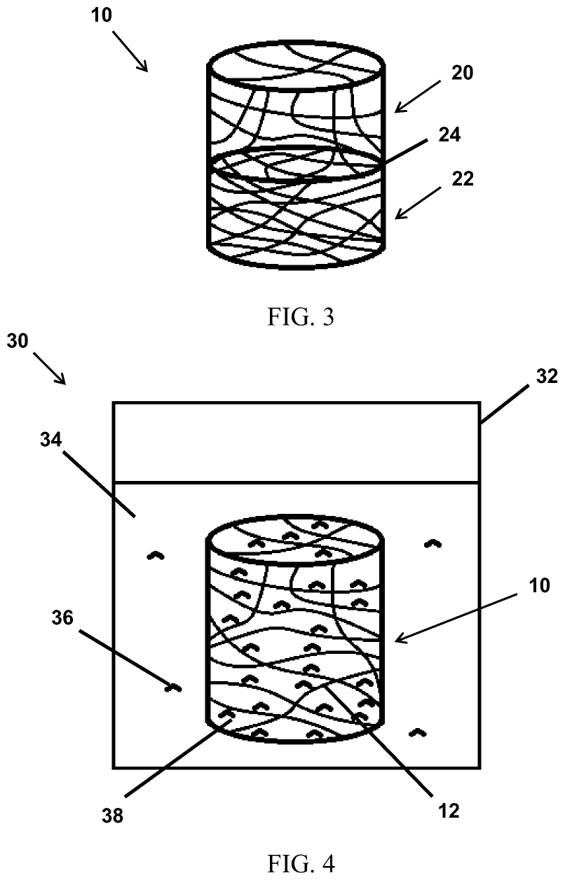

As shown in FIG. 1, in one or more embodiments, polymer gel 10 can be made of polymer chains 12 which provide generally constant bulk properties across the entirety of the polymer gel 10. As shown in FIG. 3, in one or more embodiments, polymer gel 10 can include a first section 20 having a first set of bulk properties and a second section 22 having a second set of bulk properties, where the first section 20 and the second section 22 are separated by an interface 24. While sections 20, 22 are shown as layers in the thickness direction, in other embodiments, sections 20, 22 can be inner and outer sections.

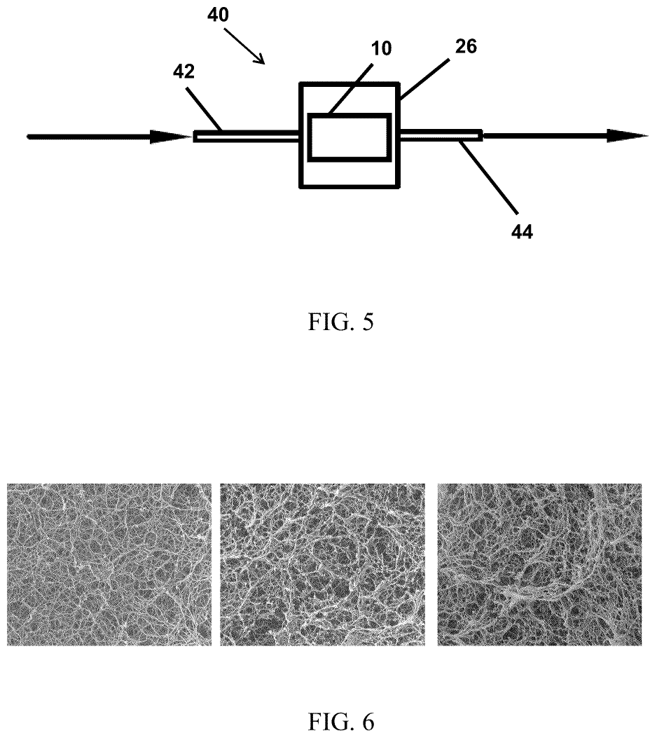

As shown in FIG. 4, in one or more embodiments, polymer gel 10 can be utilized without a separate housing. As shown in FIG. 5, in one or more embodiments, polymer gel 10 can be utilized within a housing 26.

In FIG. 4, polymer gel 10 is shown within a system 30. System 30 includes a container 32 which contains water 34. An exemplary container 32 is a personal water dispenser. Water 34 contains an initial concentration of PFAS 36. By placing the polymer gel 10 within the container 32 and water 34 therein, the polymer gel 10 will adsorb a desired amount of adsorbed PFAS 38, to thereby produce water 34 having a lower concentration of PFAS 36. The water 34 having the lower concentration of PFAS 36 can then be utilized, such as a user drinking the water having the lower concentration of PFAS 36. When the polymer gel 10 has adsorbed a certain amount of adsorbed PFAS 38, the spent polymer gel 10 can be removed and replaced, which can include appropriately disposing or regenerating the polymer gel 10.

In FIG. 5, polymer gel 10 is shown within a system 40. The polymer gel 10 is within housing 26. Housing 26 receives an inlet 42 which provides water containing an initial concentration of PFAS. The polymer gel 10 within housing 26 will then adsorb a desired amount of PFAS from the inlet 42 to thereby produce water having a lower concentration of PFAS. The water having the lower concentration of PFAS can then exit via outlet 44 in order to be utilized, such as a user drinking the water having the lower concentration of PFAS.

While the Figures show only a single polymer gel 10 or housing 26 in use, other embodiments could include utilizing a plurality of polymer gels 10 or housings 26. The plurality of polymer gels 10 or housings 26 could either be in series or in parallel.

The polymer gel 10 or housing 26 could also be used in conjunction with other filtration or separation devices, such as within a city water treatment system. Exemplary other apparatuses which may be utilized in conjunction with polymer gel 10 or housing 26 include membranes, molecular sieving, barrier filters, gravity settlers, and centrifugal inertial separators.

The polymer gel 10 or housing 26 can be operated either in batch (FIG. 4) or continuous operation (FIG. 5). The polymer gel 10 or housing 26 can be operated either in single pass operation or multi-pass operation. Single pass operation generally refers to the water passing through the polymer gel 10 or housing 26 one time. Multi-pass operation generally refers to the water passing through the polymer gel 10 or housing 26 multiple times, which may also be referred to as recycle.

In light of the foregoing, it should be appreciated that the present invention advances the art by providing improvements for removing undesired compounds from water. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

### Example 1

A first example was run with embodiments of the polymer gel disclosed herein according to these specifics. A water stream with perfluorooctanoic acid (PFOA) at the environmentally relevant concentration of 1 μg/L was utilized for each test for the materials below. Solid weights of 100 mg of the materials were used for performing the adsorption experiments. The time for the adsorption experiments was 4 hours. The separation efficiencies are reported in the below Table 1.

TABLE 1

| Material | Separation Efficiency (%) |
|---|---|
| Syndiotactic polystyrene | 99.97 |
| Chitosan | 95.10 |
| Silica | 91.68 |
| Polyurea | 99.63 |
| Polyimide | 98.13 |

### Example 2

Syndiotactic polystyrene (Mw about 300,000 g/mol, 98%) was procured from Scientific Polymer Producers Inc. (Ontario, NY, U.S.A.). Toluene was purchased from Sigma Aldrich (Milwaukee, WI, U.S.A). Ethanol was purchased from Decon Laboratories Inc. (King of Prussia, PA, U.S.A.). Perfluorooctanoic acid (PFOA, 96%) and perfluoroheptanoic acid (purity greater than 98.0%, used as an internal standard) were purchased from Sigma Aldrich (Milwaukee, WI, U.S.A). All chemicals were used as received without further purification.

Syndiotactic polystyrene (sPS) gels were obtained by thermo-reversible gelation of solutions of sPS in toluene. sPS solutions were prepared with solid concentrations of 0.02, 0.06, and 0.08 g/mL by dissolving sPS in toluene in sealed vials at 100° C. and allowing the solutions to cool under ambient conditions for 1 min followed by pouring into a covered cylindrical glass mold with 15 mm diameter for gelation. The gels were allowed to stand in the mold for 5 h to ensure complete gelation, demolded, and solvent exchanged first with ethanol and finally with deionized (DI) water to obtain water-filled sPS gels. To obtain sPS aerogels, the ethanol-filled sPS gels were solvent-exchanged with liquid carbon dioxide and dried under supercritical condition of carbon dioxide at 50° C. and 11 MPa pressure to recover sPS aerogels. The aerogels were used for BET surface area measurement and for examining morphology using scanning electron microscope (SEM).

A helium pycnometer (AccuPyc II 1340, Micromeritics Instrument Corp., Norcross, GA) was used to obtain skeletal density (ρₛ). The bulk density (ρ_{b}) was obtained from weight and volume of cylindrical aerogel monolith specimens. The bulk and skeletal density yielded total porosity (Π_{T}) and total pore volume (V_{Total}) of the aerogels as expressed above.

The Brunauer-Emmett-Teller (BET) adsorption-desorption analysis was used to obtain specific surface area and mesopore volume of the sPS aerogels. A Micromeritics Tristar II 3020 analyzer (Micromeritics Instrument Corp., Norcross, GA) was used for this purpose to obtain N₂ adsorption-desorption isotherms at 77 K. The nonlocal density functional theory (NLDFT) model was used to obtain the mesopore volume fraction from N₂ isotherms at 77 K. The macropore (diameter>50 nm) volume was obtained from the difference of total pore volume and the mesopore volume. The fractions of meso- and macro-pores were calculated as expressed above. The morphology of the aerogel specimens was examined using a scanning electron microscope (SEM JSM5310, JEOL, MA).

The amount of PFOA present in water was determined using a mass spectrometry technique using a calibration curve. For generating the adsorption isotherm, PFOA solutions of concentrations ranging from 0.0001-5 μg/L were used and a known solid mass of the sPS gel was dipped in these solutions for 24 h. The amount of the PFOA adsorbed by the solid sPS gel was obtained by analyzing the before and after amounts of the PFOA present in water and this quantity was converted to mass of PFOA adsorbed (μg)/solid mass of sPS (g). The separation efficiency was calculated as expressed above. For obtaining the adsorption kinetic curves, 10 mL solutions of 1 μg/L concentration of PFOA were taken and sPS gels, obtained with 0.06 g/mL sPS concentration, were dipped in them for various times (5 to 1440 min). All experiments were performed three times.

The separation efficiency was trended as a function of bulk PFOA concentration. At the environmentally relevant concentration of 1 μg/L, the separation efficiency of the sPS gel was found to be 99.98%, achieved in about 24 h. The PFOA concentration in water after adsorption by the sPS gel reduced to about 0.2 ng/L or 0.2 ppt in 24 h.

It was further observed that the sPS gel showed separation efficiency of >90% for all PFOA concentrations below 1 μg/L. Specifically, the values of separation efficiency were 92.5, 94.1, 99.7, and 99.3% for PFOA concentrations of respectively 0.0001, 0.001, 0.01, and 0.1 μg/L. This data supports sPS gels being highly effective in removing PFOA even when present in extremely low concentrations.

The effects of sPS concentration in the gel on adsorption performance of PFOA molecules were analyzed. sPS gels were prepared from 0.02, 0.06, and 0.08 g/mL sPS in toluene producing specimens with different values of total porosity, pore size, and specific surface area. Results are presented in the below Table 2.

TABLE 2

| sPS solid | | Total | BET | | |
|---|---|---|---|---|---|
| concentration | Bulk density | porosity | surface | V_{Total} | fₘₑₛₒ; |
| (g/mL) | (r_{b}; g/cm³) | (P_{T}) (%) | area (m²/g) | (cm³/g) | f_{macro} |
| 0.02 | 0.031 ± 0.001 | 97.1 | 313 ± 7 | 31.3 | 0.02; 0.98 |
| 0.06 | 0.080 ± 0.003 | 92.3 | 296 ± 15 | 11.5 | 0.06; 0.94 |
| 0.08 | 0.105 ± 0.004 | 90 | 280 ± 10 | 8.6 | 0.07; 0.93 |

A higher solid polymer concentration in the gel resulted in an increase of sPS strand diameter and a reduction of the pore size and pore volume of the gel. The sPS gels showed porosity of about 97, 92, and 90% and total pore volume of about 31, 11.5, and 8.6 cm³/g at sPS concentration of 0.02, 0.06 and 0.08 g/mL. It is apparent that the pore volume reduced from 31 cm³/g to 8.6 cm³/g with a four-fold increase of sPS concentration from 0.02 to 0.08 g/mL. The more open pore structure offered by the gel with 0.02 g/mL sPS was evident from the high magnification SEM images shown in FIG. 6. In FIG. 6, the leftmost image is sPS concentration of 0.02, the middle image is sPS concentration of 0.06, and the rightmost image is sPS concentration of 0.08 g/mL.

The sPS strand diameter was thinnest at 0.02 g/mL of sPS concentration with the highest specific surface area of about 313 m²/g compared to 296 m²/g and 280 m²/g respectively for sPS gel with 0.06 and 0.08 g/mL concentration. The BET adsorption-desorption isotherms for the three sPS aerogels were analyzed. The meso- and macropore volume fraction of the three sPS gels were different. The sPS aerogel produced from 0.08 g/mL concentration had a mesopore volume fraction of about 7% which was highest among the three aerogels. It was followed by sPS aerogels produced with 0.06 g/mL (5%) and 0.02 g/mL (2%) concentration. The parameters such as the total pore volume, pore size, and specific surface area of sPS gel can be tuned for PFOA adsorption performance. The PFOA adsorption experiments were performed by keeping the solid weight of the sPS gel for all the three systems constant at 100 mg allowing the total pore volume and total BET surface area to play a key role in governing the adsorption behavior.

The sPS gel solid concentration was found to play a role in the rate of adsorption. The sPS gel obtained from 0.02 g/mL sPS concentration in solution was able to reach about 84% separation efficiency within 30 mins, while the other two gels with solid concentration of 0.06 and 0.08 g/mL reached separation efficiency values of about 72 and 32% within the same time. The difference in adsorption performance between the 0.02 g/mL and 0.08 g/mL sPS gel was quite large, and indicated the parameters pore volume, pore size, or specific surface area were found to affect the adsorption process. After 120 mins, the 0.02 g/mL sPS gel was able to remove about 99.2% of PFOA molecules. The sPS gel produced from 0.06 g/mL sPS concentration needed about 12 h to reach a 99% separation efficiency.

The above trend is first believed to be based on the PFOA adsorption being largely a pore volume driven process, resulting from the entrapment of PFOA molecules within the meso- and macro-pores of the sPS gel. Thus, a specimen with larger pore volume, such as the sPS 0.02 g/mL gel, allowed higher adsorption capacity and the ability to pack greater number of PFOA molecules. Second, the PFOA adsorption by the sPS gel is a surface-area driven process. Thus, the gel specimen produced from sPS 0.02 g/mL with a surface area of 313 m²/g resulted in faster adsorption of PFOA molecules compared to the gels produced from 0.06 g/mL and 0.08 g/mL sPS concentration and with specific surface area of 296 and 280 m²/g, respectively.

An experiment was performed to evaluate the extent of reusability of the sPS gels for removing the PFOA molecules from water until a separation efficiency of less than 90% was observed. This test answered if a gel that adsorbed, for example, 99.98% of PFOA from an industrially relevant concentration in water has more capacity to adsorb PFOA molecules when dipped in a fresh PFOA solution in water. For this purpose, a water filled sPS gel of 70 mg solid weight produced with 0.06 g/mL solid concentration was dipped in a 10 mL solution of 1 μg/L PFOA. The gel was allowed to adsorb PFOA molecules for 24 h and subsequently transferred to another 10 mL solution of 1 μg/L PFOA in water. The process was repeated 5 times each time with 24 h adsorption, and the separation efficiency of each step was calculated.

The stepwise efficiency gradually dropped and reduced to lower than 90% after the 4th cycle. In the first 4 cycles, the separation efficiency was 99.98, 97.98, 92.5, and 90.15% respectively. This shows the ability of sPS gels to adsorb PFOA repeatedly even when the equilibrium adsorption ability of the gel was reached at the end of each step, particularly for a real-world situation where the sample may be repeatedly subjected to relatively lower PFOA concentrations of less than 1 μg/L. In this regard, the repeated usability of sPS gel, in this study five times, before its separation efficiency dropped to below 90%, shows the adsorbent can be used for longer times without the need for frequent regenerations.

Various modifications and alterations that do not depart from the scope and spirit of this invention will become apparent to those skilled in the art. This invention is not to be duly limited to the illustrative embodiments set forth herein.

What is claimed is:

1. A polymer gel for removing undesired compounds from water, the polymer gel comprising polymer chains having an interconnected network of mesopores and macropores therebetween, the mesopores having pore sizes between about 2 nm and 50 nm and the macropores having pore sizes greater than about 50 nm, wherein the polymer gel has a surface area of from about 200 m²/g to about 1,000 m²/g, and wherein the polymer gel has a total porosity of from about 90% to about 97%.

2. (canceled)

3. The polymer gel of claim 1, wherein the polymer chains include polystyrene, polyimide, polyurea, polyurethane, chitosan, silica, polybenzoxazine, or cellulose.

4. The polymer gel of claim 1, wherein the polymer chains include syndiotactic polystyrene.

5. The polymer gel of claim 1, wherein the mesopores and macropores are filled with water, such that the polymer gel is a hydrogel.

6. The polymer gel of claim 1, wherein the mesopores and macropores are filled with air, such that the polymer gel is an aerogel.

7. The polymer gel of claim 1, wherein the polymer gel includes from about 1% to about 15% of the mesopores and from about 85% to about 99% of the macropores relative to a total number of pores.

8. The polymer gel of claim 1, wherein the polymer gel is shaped as a monolith, a sheet, a film, spherical microparticles, or pill-shaped microparticles.

9. The polymer gel of claim 1, wherein the polymer gel has a water contact angle of greater than 60°.

10. The polymer gel of claim 1, wherein the polymer gel includes generally constant bulk properties across an entirety of the polymer gel.

11. The polymer gel of claim 1, wherein the polymer gel includes a first section having a first set of generally constant bulk properties and a second section having a second set of generally constant bulk properties different from the first set of generally constant bulk properties.

12. The polymer gel of claim 1, wherein the polymer gel is within a personal water dispenser or a city water treatment system.

13. The polymer gel of claim 1, wherein the polymer chains include a functionalized polymer having a functionalizing agent selected from sulfonic acid, amine, carboxylic acid, and benzene.

14. The polymer gel of claim 1, wherein the polymer gel comprises a sequestering additive, where the sequestering additive includes a cyclodextrin.

15. (canceled)

16. A system for removal of per- and polyfluoroalkyl substances (PFAS) from water, the system comprising
an inlet providing a PFAS-containing water stream;
a polymer gel adapted to receive the PFAS-containing water stream via the inlet;
an outlet adapted to output a product water stream having a lower concentration of PFAS than the PFAS-containing water stream;
wherein the product water stream having the lower concentration of PFAS includes less than 10 ng/L of the PFAS.

17. The system of claim 16, further comprising a housing which carries the polymer gel, wherein the product water stream having the lower concentration of PFAS includes perfluorooctanoic acid (PFOA) at a concentration of less than 0.004 ng/L and perfluorooctane sulfonate (PFOS) at a concentration of less than 0.02 ng/L.

18. The system of claim 17, wherein the housing is part of a personal water dispenser or a city water treatment system.

19. (canceled)

20. (canceled)

21. (canceled)

22. A method for removing per- and polyfluoroalkyl substances (PFAS) from water, the method comprising
providing a PFAS-containing water stream to a polymer gel, the PFAS-containing water stream including PFAS at a concentration of from about 0.001 μg/L to about 1 μg/L;
allowing the polymer gel to adsorb the PFAS within the PFAS-containing water stream; and
collecting a product having a PFAS concentration of less than 1 ng/L.

23. The method of claim 22, wherein the product having the PFAS concentration of less than 1 ng/L includes perfluorooctanoic acid (PFOA) at a concentration of less than 0.004 ng/L and perfluorooctane sulfonate (PFOS) at a concentration of less than 0.02 ng/L.

24. The method of either claim 22 or 23, further comprising preparing the polymer gel by
preparing a solution of polymer in a first solvent;
physically crosslinking or chemically crosslinking the polymer to produce an intermediate polymer gel; and
solvent exchanging the first solvent with water to thereby form the polymer gel as a water-filled gel.

25. The method of either claim 22 or 23, further comprising preparing the polymer gel by preparing a solution of polymer in a first solvent;
physically crosslinking or chemically crosslinking the polymer to produce an intermediate polymer gel;
supercritically drying the intermediate polymer gel to form an aerogel; and
adding water to the aerogel to thereby form the polymer gel as a water-filled gel.
